(19) United States
(12) Patent Application Publication
(10) Pub. No.: US 2025/0273704 A1
(43) Pub. Date: Aug. 28, 2025

(54) FUEL CELL AND METHOD FOR MANUFACTURING FUEL CELL

(71) Applicant: HONDA MOTOR CO., LTD., Tokyo (JP)

(72) Inventors: Takanori IGARASHI, Saitama (JP); Naoki KUSHITANI, Saitama (JP); Shinya SATO, Saitama (JP)

(21) Appl. No.: 19/055,521

(22) Filed: Feb. 18, 2025

(30) Foreign Application Priority Data
Feb. 26, 2024 (JP) 2024-026449

(51) Int. Cl. H01M 8/0297; H01M 4/88

(52) U.S. Cl. CPC H01M 8/0297; H01M 4/8807

(57) ABSTRACT

To provide a fuel cell where no adhesive is used to bond an electrode layer and a gas diffusion layer to each other and a method for manufacturing the fuel cell. A fuel cell includes an electrode layer and a gas diffusion layer bonded to the electrode layer, in which the electrode layer includes an ionomer, the gas diffusion layer includes ionomer particles in at least a part of a surface facing the electrode layer, the ionomer particles are identical to the ionomer included in the electrode layer, and the ionomer particles are spray-applied.

This application is based on and claims the benefit of priority from Japanese Patent Application No. 2024-026449, filed on 26 Feb. 2024, the content of which is incorporated herein by reference.

### BACKGROUND OF THE INVENTION

### Field of the Invention

The present invention relates to a fuel cell and a method for manufacturing the fuel cell.

### Related Art

Conventionally, such a fuel cell that has a structure where a membrane electrode assembly (MEA) comprising an electrolyte film sandwiched from both sides between a pair of electrode layers, and further sandwiched from both sides by gas diffusion layers (GDLs) and a pair of separators forming a flow channel for oxygen gas (air), hydrogen gas, or liquid water to be generated, has been used. Due to lower bonding performance between the electrode layers and the gas diffusion layers, liquid water to be generated when electricity is generated may stay in areas between the electrode layers and the gas diffusion layers, leading to unstable generation of electricity. Therefore, in a conventional fuel cell 20, as illustrated in FIG. 6, electrode layers 3 and gas diffusion layers 5, which sandwich an electrolyte film 2 from both sides, are in general bonded to each other via adhesive layers 21 and gaskets 22.

However, in a structure where an electrode layer and a gas diffusion layer are bonded to each other via an adhesive layer, there has been an issue, in a step for thermo-compression bonding a separator and a support frame to each other, and, when the adhesive layer that is present between the electrode layer and the gas diffusion layer thermally expands, a membrane electrode assembly follows the expanded adhesive layer, deforms, and breaks. Then, to solve the issue of thermal expansion, such a method has been proposed where an electrode layer and a gas diffusion layer are not directly bonded to a gasket, but are bonded to each other via a film member presenting an effect of mitigating transmission of stress from the gasket to a membrane electrode assembly (see Patent Document 1).

Patent Document 1: Japanese Unexamined Patent Application, Publication No. 2023-139564

### SUMMARY OF THE INVENTION

However, in a cell of a fuel cell in Patent Document 1, it is required to use an adhesive and a new film member to bond an electrode layer and a gas diffusion layer to each other. Since it is required a step for using an adhesive and a film member, there are increases in facility cost and person hours, and it is required to select an adhesive and a material that do not present negative effects to a membrane electrode assembly.

An object of the present invention is to provide a fuel cell where no adhesive is used to bond an electrode layer and a gas diffusion layer to each other and a method for manufacturing the fuel cell.

(1) A fuel cell (for example, a fuel cell 1 described later) according to the present invention is a fuel cell including: an electrode layer (for example, an electrode layer 3 described later); and a gas diffusion layer (for example, a gas diffusion layer 5 described later) bonded to the electrode layer, in which the electrode layer includes an ionomer (for example, an ionomer 41 described later), and the gas diffusion layer includes ionomer particles (for example, ionomer particles 42 described later) in at least a part of a surface facing the electrode layer.

The fuel cell is the fuel cell including the electrode layer and the gas diffusion layer bonded to the electrode layer, in which the electrode layer includes the ionomer. On the other hand, the gas diffusion layer includes the ionomer particles in at least the part of the surface, the part corresponding to the electrode layer. Since the ionomer is a synthetic resin in which a cohesive force of metal ions is utilized to form an aggregate of high polymers, it is possible to use thermo-compression bonding to soften and bond pieces of the ionomer to each other. In bonding between the electrode layer and the gas diffusion layer including an ionomer layer, an anchor effect due to the ionomer makes it possible to achieve strong bonding. Furthermore, as the ionomer particles are included in at least the part of the surface of the gas diffusion layer, such an effect is presented that gas from the gas diffusion layer is not blocked, but is allowed to pass through the electrode layer.

(2) In the fuel cell, an ionomer included in the ionomer particles is identical to the ionomer included in the electrode layer.

Since the ionomer included in the ionomer particles is identical to the ionomer included in the electrode layer, a stronger anchor effect is exerted, making it possible to achieve a stronger bond between the electrode layer and the gas diffusion layer.

(3) In the fuel cell, the ionomer particles are an ionomer that has been spray-applied.

The ionomer particles included in the gas diffusion layer are bonded through spray-application of the ionomer onto the surface of the gas diffusion layer, the surface facing the electrode layer. Thereby, it is possible to bond the ionomer particles only to at least a part of a surface of a base material, which is disposed on a side of the gas diffusion layer, the side facing the electrode layer. That is, since it is possible to suppress infiltration of the ionomer into the gas diffusion layer 5 that is porous, and it is possible to dispose the ionomer only on a surface layer of the gas diffusion layer, it is possible to reduce an amount of use of the ionomer.

(4) A method for manufacturing a fuel cell is a method for manufacturing a fuel cell including an electrode layer and a gas diffusion layer bonded to the electrode layer, the method for manufacturing the fuel cell, including: applying an ionomer onto a surface of the gas diffusion layer, the surface facing the electrode layer; and bonding the electrode layer and the gas diffusion layer to each other such that the surface of the gas diffusion layer, the surface having the ionomer applied thereto, faces the electrode layer.

The fuel cell is manufactured with the manufacturing method including the applying the ionomer onto the surface of the gas diffusion layer, the surface facing the electrode layer, and the bonding the electrode layer and the gas diffusion layer to each other such that the surface of the gas diffusion layer, the surface having the ionomer applied thereto, faces the electrode layer. Thereby, as the electrode layer including the ionomer and ionomer particles bonded to the gas diffusion layer are bonded to each other to exert the anchor effect due to the ionomer, it is possible to achieve a stronger bond between the electrode layer and the gas diffusion layer.

(5) In the applying in the method for manufacturing the fuel cell, the ionomer is spray-applied onto the surface of the gas diffusion layer, the surface facing the electrode layer.

With the applying in which spray-applying the ionomer onto the surface of the gas diffusion layer is performed, the surface facing the electrode layer, it is possible to bond the ionomer particles only to at least a part of the surface of the base material disposed on the side of the gas diffusion layer, the side facing the electrode layer. That is, since it is possible to suppress infiltration of the ionomer into the gas diffusion layer 5 that is porous, and it is possible to dispose the ionomer only on the surface layer of the gas diffusion layer, it is possible to reduce an amount of use of the ionomer.

According to the present invention, since the ionomer particles are provided on at least the part of the surface of the gas diffusion layer, the part corresponding to the electrode layer, it is possible to achieve a stronger bond between the electrode layer and the gas diffusion layer, making it possible to provide a fuel cell where no adhesive is used to bond the electrode layer and the gas diffusion layer to each other. Thereby, it is possible to reduce the cost of an adhesive used, and it is possible to prevent liquid water from staying in an area between the electrode layer and the gas diffusion layer.

### BRIEF DESCRIPTION OF THE DRAWINGS

FIG. 1 is a view illustrating a cross sectional view of a membrane electrode assembly according to a present embodiment;

FIG. 2 is a schematic view illustrating a situation where an ionomer is sprayed and applied onto a gas diffusion layer;

FIG. 3 is a schematic view illustrating a situation where a slot die coater is used to apply the ionomer onto the gas diffusion layer;

FIG. 4 is a cross sectional view illustrating a state of bonding between an electrode layer and a gas diffusion layer, according to an example;

FIG. 5 is a graph illustrating a relationship between an ionomer impregnation amount and peeling strength, according to the example; and

FIG. 6 is a cross sectional view illustrating a conventional situation where electrode layers and gas diffusion layers are bonded to each other via an adhesive and gaskets.

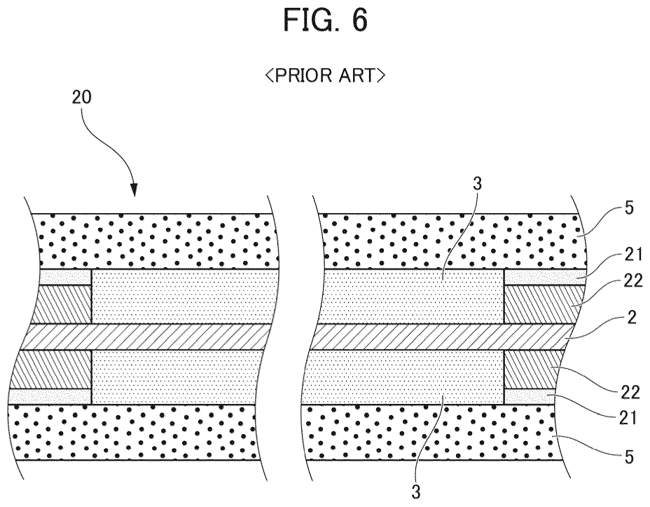

### DETAILED DESCRIPTION OF THE INVENTION

An embodiment of the present invention will now be described herein in detail with reference to the accompanying drawings. A configuration of a fuel cell 1 will now first be described.

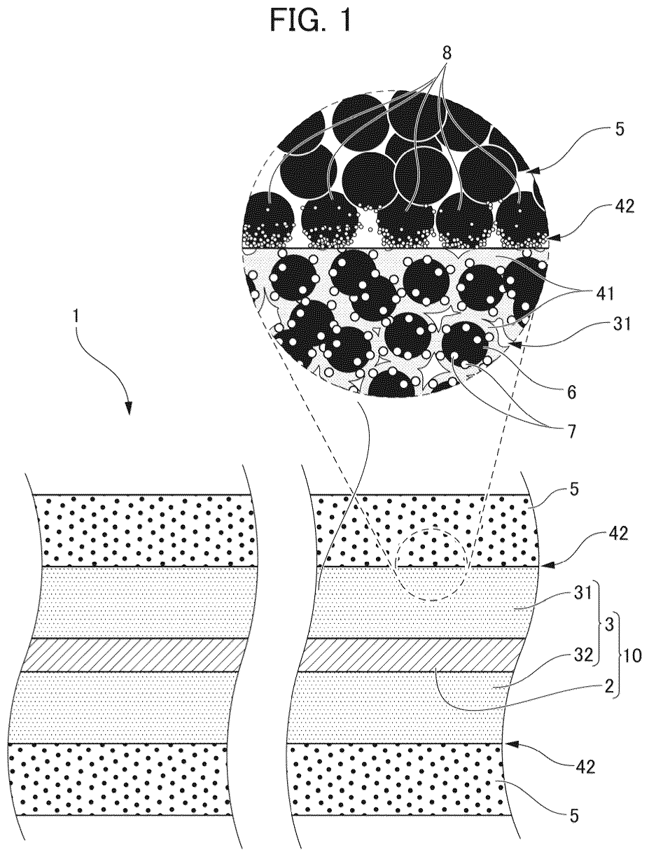

As illustrated in FIG. 1, the fuel cell 1 is a solid high polymer fuel cell including a membrane electrode assembly (MEA) 10, gas diffusion layers (GDLs) 5, and non-illustrated separators. The solid high polymer fuel cell is advantageous due to its low operating temperature, short start-up time, and compact configuration, and is utilized in fields such as driving power sources for motor vehicles.

The membrane electrode assembly 10 is sandwiched by the non-illustrated separators from both sides to form the fuel cell 1. It is possible to use the fuel cell 1 as a single body, or it is possible to use a plurality of the fuel cells 1 as a stacked body. The membrane electrode assembly 10 includes an electrolyte film 2 and an electrode layer 3 that sandwich the electrolyte film 2 from both sides. An anode catalyst layer 31 is provided as a part of the electrode layer 3 on an upper side of the electrolyte film 2, and a cathode catalyst layer 32 is provided as another part of the electrode layer 3 on a lower side of the electrolyte film 2. The gas diffusion layers 5 are provided on both surface sides of the membrane electrode assembly 10, and the electrode layer 3 and the gas diffusion layers 5 are bonded to each other via ionomer particles 42.

Next, components of the fuel cell 1 according to the present embodiment will now be described in detail with reference to the accompanying drawings.

### Electrolyte Film 2

The electrolyte film 2 in the fuel cell 1 according to the present embodiment is not limited, and it is possible to adopt an electrolyte film 2 that varies in type. For example, as a proton conductive resin for the electrolyte film 2, it is possible to use, without being limited to, an aromatic-system high polymer compound acquired by introducing a sulfonic acid group into hydrocarbon-system polymers such as aromatic polyarylene ether ketones and aromatic polyarylene ether sulfones.

### Electrode Layer 3

As illustrated in FIG. 1, the electrode layer 3 includes the anode catalyst layer 31 and the cathode catalyst layer 32. The electrode layer 3 includes carbon particles (catalyst particles) 6 that support a catalyst metal 7 and an ionomer 41 that is a high polymer electrolyte. Although it is possible to use carbon black as the carbon particles 6, it is possible to adopt, in addition, for example, a carbon compound such as a solid body or a ground product of graphite, carbon fiber, or active carbon, carbon nanofiber, carbon nanotube, carbon nitride, sulfurous carbon, and phosphorus carbon. As the catalyst metal 7, it is possible to use a single body or a combination of two or more of metals such as platinum, ruthenium, iridium, rhodium, palladium, osmium, tungsten, lead, iron, chromium, cobalt, nickel, manganese, vanadium, molybdenum, gallium, and aluminum.

The ionomer 41 takes a role of bonding the carbon particles 6 to each other, and a role as a proton conductor generated through chemical reaction. Ionomers that are commonly used include perfluorocarbon sulfonic acid polymers such as Nafion (registered trademark), which is also widely used as an electrolyte material, but it is also possible to use, for example, a sulfonation plastic-system electrolyte such as sulfonation polyether ketone, sulfonation polyether sulfone, sulfonation polyether ether sulfone, sulfonation polysulfone, sulfonation polysulfide, and sulfonation polyphenylene and a sulfo-alkylation plastic-system electrolyte such as sulfo-alkylation polyether ether ketone, sulfo-alkylation polyether sulfone, sulfo-alkylation polyether ether sulfone, sulfo-alkylation polysulfone, sulfo-alkylation polysulfide, and sulfo-alkylation polyphenylene.

### Gas Diffusion Layer 5

The gas diffusion layers 5 are laminated on both sides of the membrane electrode assembly 10, and take a role of allowing reaction gas to be evenly distributed and of transmitting generated electric energy. The gas diffusion layers 5 each include base materials 8 and a porous layer in a laminated manner. Examples of the base materials 8 include electrically-conductive carbon particles, carbon paper, carbon cloth, and the like. As described above, the ionomer particles 42 are bonded to a surface of each of the gas diffusion layers 5, the surface facing the electrode layer 3. As illustrated in FIG. 1, as the ionomer 41 included in the electrode layer 3 and the ionomer particles 42 bonded to the gas diffusion layers 5 exert a bonding effect, the electrode layer 3 and the gas diffusion layers 5 are securely bonded to each other.

### Ionomer Particle 42

The ionomer particles 42 are particles of an ionomer applied and bonded to a surface of each of the base materials 8 in each of the gas diffusion layers 5. As the ionomer used as the ionomer particles 42, it is possible to use the ionomers listed in the description of the ionomer used in the electrode layer 3 described above. Preferably, the ionomer particles 42 and the ionomer 41 used in the electrode layer 3 are identical to each other.

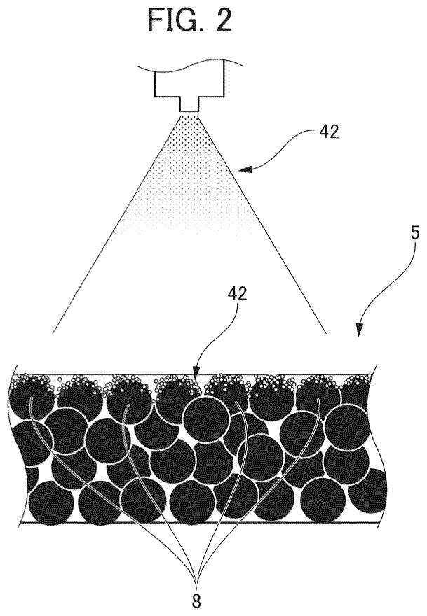

As an example described later, the ionomer particles 42 are bonded to the surface of each of the gas diffusion layers 5, the surface facing the electrode layer 3, as the ionomer is applied. Since, at this time, when the ionomer particles 42 applied without forming a gap form a layer, gas from the gas diffusion layers 5 is blocked to pass through the electrode layer 3, it is preferable that the ionomer particles 42 are bonded to at least a part of the surface of each of the gas diffusion layers 5. Therefore, as illustrated in FIG. 2, a preferable embodiment is that the ionomer particles 42 be spray-applied onto and bonded to the base materials 8.

Thereby, it is possible to bond the ionomer particles 42 only to at least a part of the surface of each of the base materials 8 disposed on a side of each of the gas diffusion layers 5, the side facing the electrode layer 3, thus having an effect of allowing gas from the gas diffusion layers 5 to pass through the electrode layer 3. Furthermore, since it is possible to suppress infiltration of the ionomer into the gas diffusion layers 5 that are porous, and it is possible to apply the ionomer only to a surface layer of each of the gas diffusion layers 5, it is possible to reduce an amount of use of the ionomer.

Furthermore, surfaces of the electrode layer 3 including the ionomer 41 and the ionomer particles 42 are softened and bonded to each other through thermo-compression bonding. Thereby, in bonding of the electrode layer 3 and the gas diffusion layers 5 including the ionomer particles 42, it is possible to achieve a stronger bond through the anchor effect due to the ionomer. Note that the anchor effect in the present invention refers to a state in which ionomers softened by heat are firmly bonded to each other resulting in the bonding effect.

### Example

Next, although the present embodiment will now be described in detail based on an example, the present embodiment is not limited to the example.

### Test Method

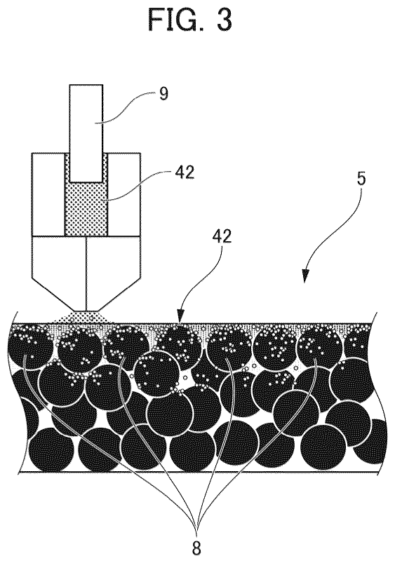

Such a test was performed where the electrode layer 3 and the gas diffusion layer 5 were securely bonded to each other via the ionomer particles 42, and, furthermore, peeling strength was measured with a force gauge when the two layers were peeled off from each other. Specifically, as illustrated in FIG. 3, a slot die coater 9 was used to first evenly apply an ionomer solution and a dispersion solvent onto the surface on one side of the gas diffusion layer 5 to allow the ionomer particles 42 to be bonded to the surface of each of the base materials 8 in the gas diffusion layer 5. At this time, attention was fully paid to make sure that the ionomer particles 42 were applied without forming a gap and were not laminated onto the gas diffusion layer 5. The ionomer particles 42 used at this time may be identical to the ionomer 41 described above. Furthermore, although, as the dispersion solvent, water, ethanol, or an alcohol-system solvent such as 1-propanol was used, a desired alcohol-system solvent may be used as long as it is possible to allow the ionomer solution to be dispersed.

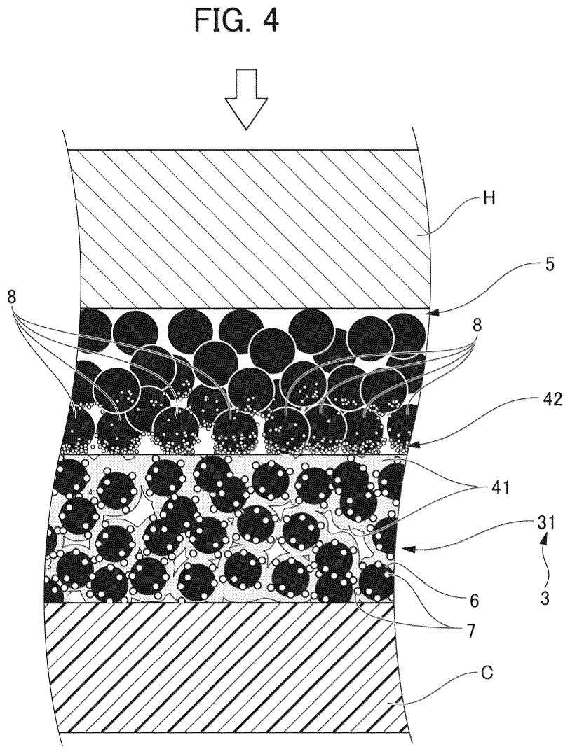

Next, as illustrated in FIG. 4, the surface of the gas diffusion layer 5, to which the ionomer particles 42 were bonded, was allowed to face an upper surface of the electrode layer 3 placed on a cushion material C, and the electrode layer 3 and the gas diffusion layer 5 were laminated to each other. Next, the gas diffusion layer 5 and the electrode layer 3 that were laminated to each other were thermally-pressed from above with a thermal surface plate H. A temperature of the thermal surface plate H was 148 degrees, thereby the gas diffusion layer 5 and the electrode layer 3 were securely bonded to each other with the anchor effect due to the ionomer. Although such a bonding method as described above was adopted in the example, a roll-to-roll (RTR) production system may be used to efficiently bond the gas diffusion layer 5 and the electrode layer 3 to each other when actually bonding a large amount of gas diffusion layers 5 and a large amount of electrode layers 3 to each other for mass-production.

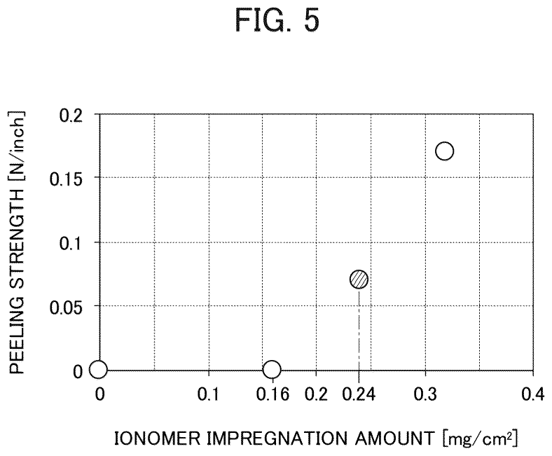

In a process of bonding the ionomer particles 42 to the gas diffusion layer 5, an amount of the ionomer to be impregnated into the gas diffusion layer 5 was incrementally changed to perform comparison of peeling strength at each impregnation amount. FIG. 5 illustrates a result of experiment and measurement of the peeling strength. According to FIG. 4, the result indicates that, around a range where the impregnation amount of the ionomer into the gas diffusion layer 5 reached approximately 0.16 mg/cm², the peeling strength exceeded 0 N/inch, and, after that, the peeling strength increased proportionately to the impregnation amount of the ionomer.

However, if the ionomer impregnation amount into the gas diffusion layer 5 increases excessively, the gas diffusion layer 5 and the electrode layer 3 become difficult to peel from each other, but, on the other hand, such an issue arises in which electricity generation performance of the fuel cell 1 lowers. In the example, the impregnation amount of the ionomer, with which the electricity generation performance did not lower, was approximately 0.24 mg/cm², and this numerical value was an optimum value of the ionomer impregnation amount in the example. However, since, in the fuel cell, porosity changes depending on a configuration of the base materials 8, which are used in a gas diffusion layer, and a porous layer, and, furthermore, a degree of penetration of the ionomer solution changes depending on a state of porosity in the gas diffusion layer, an optimum value of the ionomer impregnation amount according to the present embodiment is not limited to this numerical value. As the peeling strength between the gas diffusion layer 5 and the electrode layer 3 and the electricity generation performance of the fuel cell 1 are taken into consideration, an optimum value of the ionomer impregnation amount in the gas diffusion layer 5 is calculated.

Furthermore, it is preferable that, for the ionomer particles 42, the ionomer do not penetrate into the gas diffusion layer 5, but be evenly bonded to and applied onto only the surface of each of the base materials 8. Therefore, instead of the method for applying an ionomer using the slot die coater 9, which was used in the example, a more preferable embodiment is that, as illustrated in FIG. 2, spray coating be used to apply an ionomer onto the surface of the gas diffusion layer 5, the surface facing the electrode layer 3.

According to the present embodiment, it is possible to achieve effects described below.

The fuel cell 1 according to the present embodiment includes: the electrode layer 3; and the gas diffusion layers 5, in which the ionomer is applied onto the surface of each of the gas diffusion layers 5, the surface facing the electrode layer 3, and the ionomer particles 42 are bonded to the surface of each of the base materials 8.

Thereby, the ionomer 41 included in the electrode layer 3 and the ionomer particles 42 bonded to the surface of each of the gas diffusion layers 5 exert the anchor effect, making it possible to securely bond the electrode layer 3 and the gas diffusion layers 5 to each other. Therefore, an additional step for using an adhesive and an additional step for coupling the electrode layer 3 and the gas diffusion layers 5 to each other via gaskets become unnecessary, making it possible to reduce person hours for producing the fuel cell 1. Person hours for preparing an adhesive that does not negatively affect electrodes and films are reduced, and, with the present invention, the electrode layer 3 and the gas diffusion layers 5 are directly bonded to each other, making it possible to prevent generated liquid water from staying in areas between the electrode layer 3 and the gas diffusion layers 5. Excessive liquid water does not stay long in areas between the membrane electrode assembly 10 and the gas diffusion layers 5, making it possible to improve the electricity generation performance of the fuel cell 1.

The preferable embodiment of the present invention has been described. However, the present invention is not limited to the embodiment described above. It is possible to appropriately make modifications within the scope of the present invention.

### EXPLANATION OF REFERENCE NUMERALS

1 Fuel cell
3 Electrode layer
5 Gas diffusion layer
41 Ionomer
42 Ionomer particle

What is claimed is:

1. A fuel cell comprising:
an electrode layer; and
a gas diffusion layer bonded to the electrode layer,
wherein
the electrode layer includes an ionomer, and
the gas diffusion layer includes ionomer particles in at least a part of a surface facing the electrode layer.

2. The fuel cell according to claim 1, wherein an ionomer included in the ionomer particles is identical to the ionomer included in the electrode layer.

3. The fuel cell according to claim 1, wherein the ionomer particles are an ionomer that has been spray-applied.

4. A method for manufacturing a fuel cell including an electrode layer and a gas diffusion layer bonded to the electrode layer, the method comprising:
applying an ionomer onto a surface of the gas diffusion layer, the surface facing the electrode layer; and
bonding the electrode layer and the gas diffusion layer to each other such that the surface of the gas diffusion layer, the surface having the ionomer applied thereto, faces the electrode layer.

5. The method for manufacturing the fuel cell, according to claim 4, wherein, in the applying, the ionomer is spray-applied onto the surface of the gas diffusion layer, the surface facing the electrode layer.
